(19) United States
(12) Patent Application Publication
(10) Pub. No.: US 2004/0252825 A1
(43) Pub. Date: Dec. 16, 2004

(54) Integrated coupled inductor xDSL POTS filter apparatus

(76) Inventors: Stephen Michael Sedio, Valley Center, CA (US); Henh Ca Chenh, San Diego, CA (US)

Correspondence Address: SQUIRE, SANDERS & DEMPSEY L.L.P., Two Renaissance Square, Suite 2700, 40 North Central Avenue, Phoenix, AZ, 85004-4440, US

(21) Appl. No.: 10/458,635

(22) Filed: Jun. 10, 2003

(51) Int. Cl. H04M 1/00; H04M 9/00

(52) U.S. Cl. 379/391; 379/387.01

(57) ABSTRACT

The present invention provides a passive electronic filter circuit for telephony equipment used in conjunction with xDSL that reduces the number of discrete components over existing filters. In one exemplary embodiment the present invention employs a POTS filter having a coupled-inductor array made up of two cascaded pairs of coupled inductors that share one common ferrite core. The use of a common ferrite core reduces the number of coupled inductor packages required to perform the same filtering.

### BACKGROUND OF THE INVENTION

1. Field of the Invention

This invention relates generally to electronic filter circuits for plain old telephone system (POTS) lines and more specifically to an integrated coupled inductor for use in a POTS filter.

2. General Background and State of the Art

The growing demand for broadband data reception has lead to the growing popularity of digital subscriber lines (DSL). DSL provides for high speed data transference and reception over regular twisted-pair copper telephone lines, sometimes referred as plain old telephone system (POTS) lines. DSL provides for the transmission of both voice and high speed data transmission over the POTS line. For example, in one implementation of asymmetrical DSL or ADSL, the signals on the telephone line are split into three distinct bands: the voice band operating from 0-4 kHz, an upstream data band operating between 25 and 160 kHz and a downstream data band operating above 240 kHz. The downstream data band has greater bandwidth than the upstream data band because the typical user receives more information than he/she sends. Various implementations of DSL exist including: ADSL; very high bit rate DSL, or VDSL; symmetrical DSL or SDSL, and high bit rate DSL or HDSL. DSL or xDSL, as used in this document refers to these and any other types of DSL. Where DSL is deployed, communication devices such as telephones, fax machines, DSL modems, and other devices are all connected in parallel across an existing POTS line.

The deployment of DSL modems in residences and businesses (the customer's premise) typically requires the installation of a filter on all of the devices (known as POTS devices) sharing the same POTS line as the DSL modem. This is because intrusion in the form of noise may occur in one channel (such as the voice channel) due to signal transmissions in another channel signal (such as the upstream data channel). For example, xDSL signals and POTS signal can interact with magnetically non-linear components in the POTS device to cause audible noise, such as a hum, in a voice telephone conversation. Also, when a POTS device goes from an on hook status to an off hook status the impedance of the POTS device changes, which can result in transient noise in the xDSL channel.

The POTS filter may be implemented as part of a POTS splitter which both splits and filters the incoming POTS line and/or as a filter connected directly to the POTS device. The POTS filter functions to separate the low frequency telephony signals from the higher frequency data signals by filtering out the xDSL data signals.

Currently, passive POTS filters are manufactured using discrete capacitors and a plurality of inductors or coupled inductors. Because current filters require a large number of discrete components they require more space and are more expensive. What is needed is a way to reduce the components of a POTS filter, resulting in smaller filters and reduced costs.

### SUMMARY OF THE INVENTION

The present invention provides a passive electronic filter circuit for telephony equipment used in conjunction with xDSL that reduces the number of discrete components over existing filters. In one exemplary embodiment the present invention employs a POTS filter having a coupled-inductor array made up of two cascaded pairs of coupled inductors that share one common ferrite core. The use of a common ferrite core reduces the number of coupled inductor packages required to perform the same filtering.

Many modifications, variations and combinations of the methods and systems of filtering are possible in light of the embodiments described herein. The description above and many other features and attendant advantages of the present invention will become apparent from a consideration of the following detailed descriptions when considered in conjunction with the accompanying drawings.

### BRIEF DESCRIPTION OF THE DRAWINGS

A detailed description with regard to the embodiments in accordance with the present invention will be made with reference to the accompanying drawings; wherein:

FIG. 1 shows an exemplary circuit diagram of a filter circuit of the present invention which is adopted to mate with a POTS communication device;

FIG. 2 shows a diagram of a common ferrite core;

FIG. 3 is an overhead view of two coil formers installed on an EE10 core; and

FIG. 4 is a side view of two coil formers installed on an EE10 core.

### DETAILED DESCRIPTION OF THE PREFERRED EMBODIMENTS

The following description should not be taken in a limiting sense but is made for the purpose of illustrating the general principles of the invention. The section titles and overall organization of the present detailed description are for purposes of convenience only and are not intended to limit the present invention. As used in this document, a coupled inductor is a device that uses electromagnetic induction to transfer electrical energy from one circuit to another, usually with a change in voltage or current.

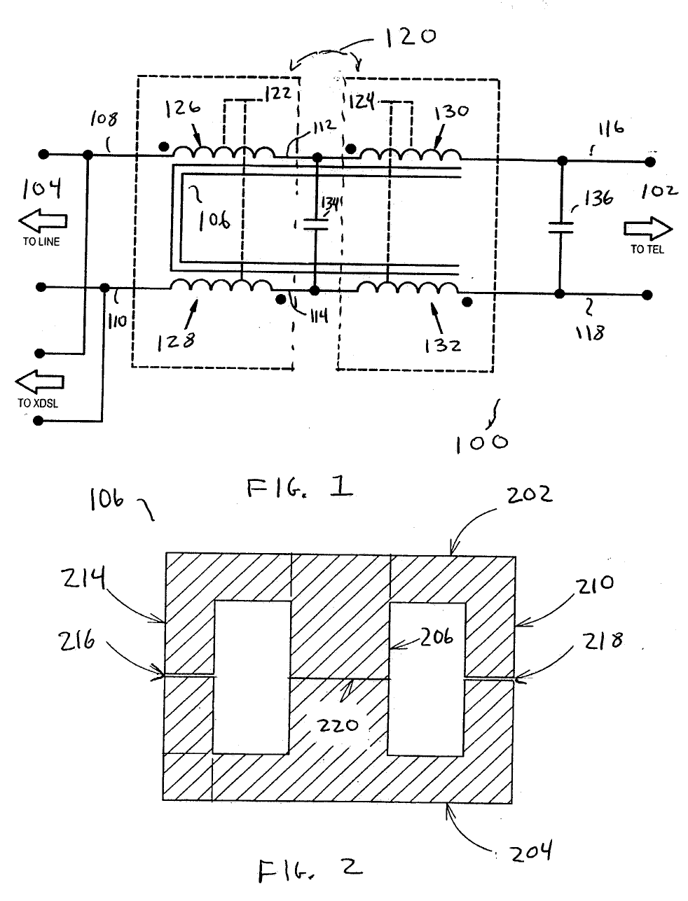

FIG. 1 shows an exemplary circuit design of a filter 100 of the present invention, which is adapted to mate a POTS communication device 102 with a POTS line 104. The unfiltered xDSL signal 105 is typically sent to a DSL modem. Filter 100 includes a coupled inductor array 120 comprising a first coupled inductor 122 and a second coupled inductor 124. First coupled inductor 122 comprises a first inductor 126 and a second inductor 128. Second coupled inductor 124 comprises a third inductor 130 and a fourth inductor 132. First coupled inductor 122 and second coupled inductor 124 share a single common core 106. A first shunt capacitor 134 is provided between lines 112 and 114 and a second shunt capacitor 136 is provided between output lines 116 and 118 of second coupled inductor 124.

In a preferred embodiment, common core 106 is a MnZn ferrite core of EE10 geometry as illustrated in FIG. 2. An exemplary ferrite core 106 is Part No. FCI-9.70/12.4/2.85 manufactured by Nippon Ceramic Co., Ltd. Common core 106 includes a right leg 210, a left leg 214 and a center leg 206. The cross-sectional area of center leg 206 is chosen to be relatively large as compared to the other cross-sectional areas of the magnetic paths in common core 106. This gives center leg 206 a low reluctance path for magnetic flux passing through it and functions as a low reluctance return path for magnetic fluxes created by the first coupled inductor 122 and second coupled inductor 124. This results in less magnetic flux transferred between first coupled inductor 122 and second coupled inductor 124. This decouples third and fourth inductors 130 and 132 from first and second inductors 126 and 128. The inductor pairs 126 and 128 in first coupled inductor 122 and the inductor pairs 130 and 132 of second coupled inductor 124 posses high magnetic coupling. In one exemplary embodiment, the magnetic coupling between the first inductor 126 and second inductor 128 of first coupled inductor 122 and between third inductor 130 and fourth inductor 132 of second coupled inductor 124 has a magnetic coupling coefficient of 0.95 (close to the theoretical value of one). Third inductor 130 and fourth inductor 132 are decoupled magnetically from first inductor 126 and second inductor 128. In one exemplary embodiment, the magnetic coupling coefficient is 0.003, which is close to the ideal value of zero needed for total decoupling. Thus, first coupled inductor 122 is almost totally isolated from second coupled inductor 124. While two coupled inductors, 122 and 124, are shown, more than two coupled inductors can be used without departing from the scope of the present invention.

Core 106 is divided into a first half 202 and a second half 204. The face of the left leg 214 and the face of the right leg 210 of one of the halves (such as the first half 202) are grounded down, milled down or shaved away to create a first air gap 216 and a second air gap 218. In an exemplary embodiment, the gap thickness is 0.18 mm+/−0.05 mm. Varying the gap thickness varies the open circuit inductance of the inductors 126, 128, 130 and 132. In an exemplary embodiment, the thickness of the first air gap 216 and the second air gap 218 are chosen such that the open circuit induction of inductors 126, 128, 130 and 132 are sufficient to give the filter 100 the desired filter response. In an exemplary embodiment the open circuit inductance for each inductor 126, 128, 130 and 132 is 4.5 mHy at 1.0 kHz and 100 mVrms.

In one exemplary embodiment, a thin layer of epoxy resin, such as Nagase ChemTex XNR3501SL, is optionally applied between the matting face of center leg 206 of the first half 202 and the second half 204 of common core 106. Pressure is then provided to control the resin layer thickness. Once hardened the thin layer of epoxy creates a very small center leg adjustment gap 220. Center leg adjustment gap 220 is non-ferromagnetic and helps to reduce the magnetic reluctance of the center leg 206 and decrease the magnetic coupling coefficient. Slight adjustments to the center leg adjustment gap 220 can adjust the magnetic coupling coefficient of the center leg 206. Instead of using an adjustable gap, the magnetic coupling coefficient can be adjusted by other means known to those in the art including varying the cross-sectional area of center leg 206.

Shunt capacitors 134 and 136 are, in an exemplary embodiment, film capacitors. In one exemplary embodiment, shunt capacitor 134 is a 33 nFd capacitor and shunt capacitor 136 is a 47 nFd capacitor.

In the embodiment of the invention as illustrated in FIG. 1, the filter 100 is a double L-section (LCLC) passive 4^{th} Order Chebyshev low pass filter. The desired filter response can be chosen by providing appropriate core path lengths, core path cross sectional areas, adjustable gap thickness and air gap thickness. Of course, other filters can be utilized such as a 3^{rd} Order Butterworth low pass filter and a 5^{th} Order Bessel low pass filter, wherein two or more coupled inductors in those filters share a common core. In an exemplary embodiment, filter 100 has an insertion loss of −1.5 dB between 2.2 kHZ and 3.5 kHz, a passband ripple of 1.5 dB and a high frequency roll-off of −55 dB to −65 dB over 30 kHz to 1.1 MHz.

By careful selection of component values and parameters, the responses of the filter of the present invention will be almost the same as a filter with a conventional design using separate cores. Thus, the filter of the present invention will filter out the xDSL signal such that it does not reach the POTS device. Also, the relatively high impedance looking into the filter from the line side, swamps out the impedance changes occurring on the other side of the POTS filter in the POTS device.

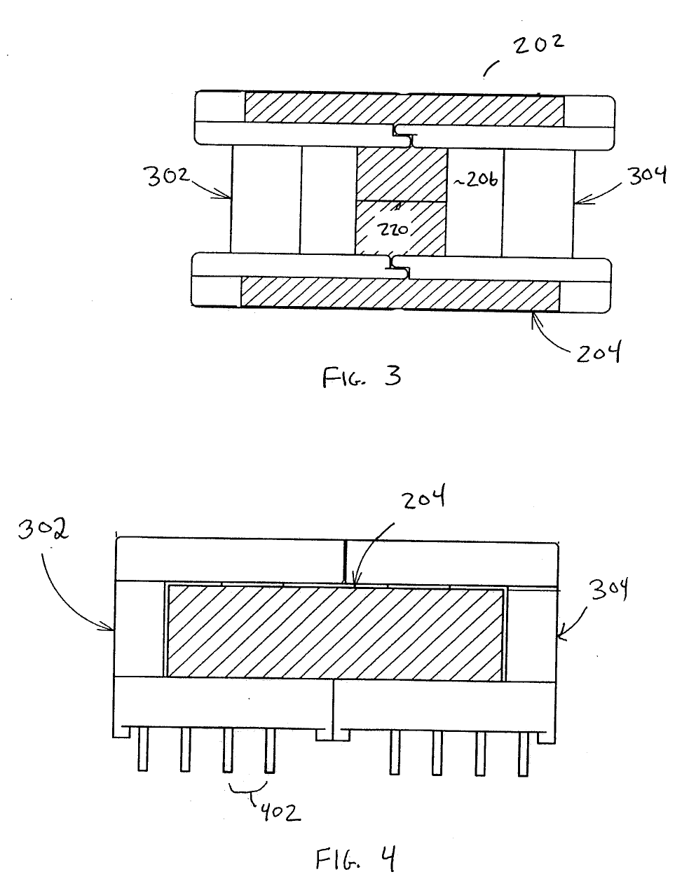

In an exemplary embodiment, the coupled inductor array 120 is installed on a base for mounting on a printed circuit board. As seen in FIGS. 3-4, a first coil former 302 and second coil former are installed around core 106 to form a base. The first coil former 302 and the second coil former 304 are a combination of a mounting base and winding bobbin. An exemplary coil former is PIN Base-SLF 1312-F8P, manufactured by Sumida Corp. of San Diego, Calif. In one exemplary embodiment, first coupled inductor 122 includes two coils, each coil wound bifilarly and each coil having 195 turns of #34.5 AWG HPN enamel coated wire (magnet wire) in 14 layers on first coil former 302. In FIGS. 3-4 the wire coils are not pictured in order to better see the first coil former 302 and the second coil former 304. In the exemplary embodiment, second coupled inductor 124 also includes two coils, each coil wound bifilarly and each coil having 195 turns of #34.5 AWG HPN enamel coated wire (magnet wire) in 14 layers on second coil former 302.

First coil former 302 and second coil former 304 are mechanically secured to each other and around core 106 to form a package that can be mounted on a printed circuit board. As seen in FIG. 4, there is a plurality of electrical terminals 402 for use in mounting the package on a printed circuit board and connecting to external components such as RJ-11 connectors for coupling the POTS line and POTS devices as well as the shunt capacitors in order to form a complete POTS filter unit.

Notwithstanding that FIG. 1 shows coupled inductors whose windings aid one another rather than oppose one another in the establishment of the magnetic fields within their respective cores, the scope of this invention includes the incorporation of coupled-inductors, such as second coupled inductor 124, whose windings create magnetic fields that oppose one another; that is, the scope of this invention includes “common-mode” coupled inductors. Such transformers can be placed in cascade with any other transformer(s), provided that the first coupled inductor 122 is the coupled inductor connected to the telephone line.

Although specific components with particular operating parameters are described in the preferred embodiment, a variety of different components with varying operating parameters may be used which do not depart from the scope of the present invention. The preferred embodiment described above are for exemplary purposes only. While the filter circuit can be configured as a separate electrical element, it should be appreciated that the circuit can readily be incorporated into the design of a telephone or other device connected to the POTS line. The invention applies to all types of combinations and/or rearrangements of the methods and systems described. It is to be understood that the invention is not limited to these specific embodiments. With respect to the claims, it is the applicant's intention that the claims not be interpreted in accordance with the sixth paragraph of 35 U.S.C. § 112 unless the term “means” is used followed by a functional statement.

What is claimed is:

1. A filter for POTS devices used in a xDSL environment comprising a coupled inductor array sharing a common core.

2. The filter of claim 1 wherein the common core is an EE10 core.

3. The filter of claim 2 wherein the cross sectional area of a center leg of the core is chosen to maximize magnetic decoupling.

4. The filter of claim 1 wherein the filter is a 4^{th} Order Chebyshev filter.

5. The filter of claim 1 wherein the filter has a pass band that includes an analog voice channel in a xDSL signal.

6. The filter of claim 2 wherein a left leg and a right leg of the EE10 core includes an air gap.

7. The filter of claim 2 wherein a resin layer is applied between a face of a first half of a center leg and a face of a second half of a center leg of the EE10 core, the resin layer forming an adjustment gap effecting the magnetic reluctance of the center leg.

8. The filter of claim 1 wherein the coupled inductor array comprises two or more cascaded coupled inductors sharing a common core.

9. A method for filtering xDSL signals on a POTS line having at least one POTS device and a DSL modem sharing the POTS line comprising:
for each POTS device, providing a passive electrical filter comprising two or more cascaded coupled inductors sharing a common core; and
connecting the passive electrical filter between the POTS line and the POTS device.

10. The method of claim 9 wherein the step of providing a passive electrical filter further comprises providing a passive electrical filter comprising two or more cascaded coupled inductors sharing a common EE10 core.

11. The method of claim 10 further comprising providing an air gap on a left leg and a right leg of the EE10 core to adjust the open circuit loop inductance.

12. The method of claim 10 further comprising providing a resin layer between a top half of a center leg of the EE10 core and a bottom half of a center leg of the EE10 core to create adjustment gap.

13. An electrical filter for a POTS device connected to a POTS line:
a first coupled inductor;
a second coupled inductor cascaded with the first coupled inductor;
a core common to both the first coupled inductor and the second coupled inductor;
a first shunt capacitor coupled across a pair of conductors coupling the first coupled inductor and the second coupled inductor; and
a second shunt capacitor coupled across a pair of output lines.

14. The electrical filter of claim 13 wherein the common core is an EE10 core.

15. The electrical filter of claim 14 wherein the cross sectional area of a center leg of the EE10 core is chosen to maximize magnetic decoupling.

16. The electrical filter of claim 13 wherein the filter is a 4^{th} Order Chebyshev filter.

17. The electrical filter of claim 13 wherein the filter has a pass band that includes an analog voice channel in a xDSL signal.

18. The electrical filter of claim 14 wherein a left leg and a right leg of the EE10 core include an air gap.

19. The electrical filter of claim 14 wherein a resin layer is applied between a face of a first half of a center leg and a face of a second half of a center leg of the EE10 core, the resin layer forming an adjustment gap effecting the magnetic reluctance of the EE10 core.

20. The electrical filter of claim 13 wherein the filter is integrated into a POTS device.
